(19) United States
(12) Patent Application Publication
(10) Pub. No.: US 2014/0204406 A1
(43) Pub. Date: Jul. 24, 2014

(54) IMAGE FORMING APPARATUS, HOST APPARATUS, IMAGE FORMING METHOD, PRINT CONTROL METHOD, AND COMPUTER-READABLE RECORDING MEDIUM

(71) Applicant: SAMSUNG ELECTRONICS CO., LTD., Suwon-si (KR)

(72) Inventor: Dae-hyeok IM, Suwon-si (KR)

(73) Assignee: SAMSUNG ELECTRONICS CO., LTD., Suwon-si (KR)

(21) Appl. No.: 14/070,738

(22) Filed: Nov. 4, 2013

(30) Foreign Application Priority Data
Jan. 21, 2013 (KR) 10-2013-0006714

(51) Int. Cl. G06K 15/00

(52) U.S. Cl. CPC G06K 15/4095
USPC 358/1.14

(57) ABSTRACT

An image forming apparatus, a method, and a computer-readable recording medium are provided. The image forming apparatus includes an input unit which receives image data, a detection unit which detects a printing concentration of the received image data, an image processing unit which composes a copy protection pattern and the image data so that the copy protection pattern is printed with a concentration corresponding to the detected printing concentration, and an image forming unit which prints image data composed with the copy protection pattern.

### CROSS-REFERENCE TO RELATED APPLICATIONS

This application is related to, and claims priority under 35 U.S.C. §119(a) to, Korean Patent Application No. 10-2013-0006714 filed Jan. 21, 2013 in the Korean Intellectual Property Office, the disclosure of which is incorporated herein by reference in its entirety.

### BACKGROUND

1. Field

Exemplary embodiments of the present disclosure relate to an image forming apparatus, a host apparatus, an image forming method, a print control method, and a computer-readable recording medium. More particularly, the present disclosure relates to an image forming apparatus, a host apparatus, an image forming method, a print control method, and a computer-readable recording medium that can output a copy prevention pattern, varying a concentration of the copy prevention pattern depending on a concentration of a print image.

2. Description of the Related Art

An image forming apparatus is an apparatus that can perform one or more of generation, print, reception, and transmission of image data, and may include a printer, a scanner, a copier, a facsimile machine, and/or a composite device that may integrate a plurality of the functions.

Recently, because of developments of the internet environment, it is becoming more common that payment procedures of various types of tickets are performed through the internet, and printing of the tickets or payment slips may be performed at home. Accordingly, it is becoming more common that home image forming apparatuses print printouts include a secondary basic symbol such as QR codes, etc. including various kinds of information to verify the authenticity, a primary basic barcode, or a copy prevention pattern for anti-counterfeiting.

In order to output the printouts provided with such a copy prevention pattern, two methods are conventionally used. A first method includes printing performed on a dedicated printing medium on which the copy prevention pattern has been printed. A second method is forming a copy prevention image using software, and then a document is printed so that the copy prevention image is placed in the background thereof.

The first method is widely used in government offices or companies that frequently print the copy protection pattern. However, there are problems with this method in that since dedicated printing media are used, a purchase cost of the dedicated printing media is required, and upon the dedicated printing media run out, printouts with the copy protection pattern cannot be printed out. As a result, in recent years, the second method is used.

However, when the second method is used, there is a problem that toner consumption increases over when only documents are printed since additional consumption of toner for printing the copy prevention images is required.

Accordingly, there is a need for a way to print the copy protection pattern while minimizing any increase in the toner consumption.

### SUMMARY

Exemplary embodiments of the present disclosure may overcome the above drawbacks and/or other problems associated with a conventional arrangement. Aspects of the present disclosure provide an image forming apparatus that can output a copy protection pattern, varying a concentration of the copy protection pattern depending on a concentration of a printed image, a host apparatus, an image forming method, a print control method, and a computer-readable recording medium thereof.

The above aspect and/or other feature of the present disclosure can be achieved by providing an image forming apparatus, which may include an input unit that receives image data, a detection unit that detects a printing concentration of the received image data, an image processing unit that composes a copy protection pattern and the image data so that the copy protection pattern is printed with a concentration corresponding to the detected printing concentration, and an image forming unit that prints image data composed with the copy protection pattern.

According to an exemplary embodiment, if the detected printing concentration is lower than a first predetermined concentration, the image processing unit may compose the copy protection pattern and the image data so that the copy protection pattern is printed with a concentration lower than a predetermined concentration for the copy protection pattern.

According to an exemplary embodiment, if the detected printing concentration is lower than the first predetermined concentration, the image processing unit may compose the copy protection pattern and the image data so that the copy protection pattern is printed with a concentration proportional to the detected printing concentration.

According to an exemplary embodiment, if the detected printing concentration is higher than the first predetermined concentration, the image processing unit may compose the copy protection pattern and the image data so that the copy protection pattern is printed with the predetermined concentration for the copy protection pattern.

According to an exemplary embodiment, if the detected printing concentration is lower than a second concentration lower than the first predetermined concentration, the image processing unit may not compose the copy protection pattern and the image data, and the image forming unit may print the image data with which the copy protection pattern is not composed.

The image forming apparatus can perform a color printing by using a plurality of different toners, the detection unit may detect an amount of toner of each of the plurality of toners, and the image processing unit may compose the image data and the copy protection pattern corresponding to a color of the toner having the largest amount of toner based on the detected amount of toner.

The image forming apparatus can perform a color printing by using a plurality of different toners, and the image forming apparatus may include a user interface unit in which a color of the copy protection pattern is selected, and the image processing unit may compose the image data and the copy protection pattern with the selected color.

The image forming apparatus may include a user interface unit in which at least one of a shape and a location of the copy protection pattern is selected. The image processing unit may compose the image data and the copy protection pattern based on the at least selected one of the shape and location of the copy protection pattern.

The image forming apparatus may include a communication interface unit that performs communication with a host apparatus, wherein the input unit may receive printing data received from the host apparatus through the communication interface unit as the image data.

The image forming apparatus may include a scanning unit that generates a scan image by scanning a document, wherein the input unit may receive the scan image generated by the scanning unit as the image data.

According to an aspect of the present disclosure, a host apparatus connectable to an image forming apparatus may include a detection unit that detects a printing concentration of a document when a print command for the document is received, a printer driver unit that generates printing data by composing a copy protection pattern and the document so that the copy protection pattern is printed with a concentration corresponding to the detected printing concentration, and a communication interface unit that transmits the generated printing data to the image forming apparatus.

According to an aspect of the present disclosure, an image forming method of an image forming apparatus may include receiving image data, detecting a printing concentration of the received image data, composing a copy protection pattern and the image data so that the copy protection pattern is printed with a concentration corresponding to the detected printing concentration, and printing image data composed with the copy protection pattern.

The composing a copy protection pattern and the image data may include, if the detected printing concentration is lower than a first predetermined concentration, composing the copy protection pattern and the image data so that the copy protection pattern is printed with a concentration lower than a predetermined concentration for the copy protection pattern.

The composing a copy protection pattern and the image data may include, if the detected printing concentration is lower than the first predetermined concentration, composing the copy protection pattern and the image data so that the copy protection pattern is printed with a concentration proportional to the detected printing concentration.

The composing a copy protection pattern and the image data may include, if the detected printing concentration is higher than the first predetermined concentration, composing the copy protection pattern and the image data so that the copy protection pattern is printed with the predetermined concentration for the copy protection pattern.

The composing a copy protection pattern and the image data may include, if the detected printing concentration is lower than a second concentration lower than the first predetermined concentration, not composing the copy protection pattern and the image data, and the printing image data composed with the copy protection pattern comprises printing the image data with which the copy protection pattern is not composed.

The image forming apparatus can perform a color printing by using a plurality of different toners, the detecting a printing concentration of the received image data may include detecting an amount of toner of each of the plurality of toners, and the composing a copy protection pattern and the image data may include composing the image data and the copy protection pattern corresponding to a color of the toner having the largest amount of toner based on the detected amount of toner.

The image forming apparatus can perform a color printing by using a plurality of different toners, and the image forming method may include receiving a selected color of the copy protection pattern, and wherein the composing a copy protection pattern and the image data may include composing the image data and the copy protection pattern with the selected color.

The image forming method may include receiving at least selected one of a shape and a location of the copy protection pattern, wherein the composing a copy protection pattern and the image data may include composing the image data and the copy protection pattern based on the at least selected one of the shape and location of the copy protection pattern.

The receiving image data may include receiving printing data received from a host apparatus as the image data.

The receiving image data may include generating a scan image by scanning a document, and receiving the generated scan image as the image data.

According to an aspect of the present disclosure, a print control method of a host apparatus connectable to an image forming apparatus may include receiving a print command for a document, detecting a printing concentration of the document, generating printing data by composing a copy protection pattern and the document so that the copy protection pattern is printed with a concentration corresponding to the detected printing concentration, and transmitting the generated printing data to the image forming apparatus.

According to an aspect of the present disclosure, a computer-readable recording medium may include a program for executing a print control method, and the print control method may include receiving a print command for a document, detecting a printing concentration of the document, generating printing data by composing a copy protection pattern and the document so that the copy protection pattern is printed with a concentration corresponding to the detected printing concentration, and transmitting the generated printing data to the image forming apparatus.

Other advantages and features of an exemplary embodiment of the present invention are apparent from the following detailed description, taken in conjunction with the drawings.

### BRIEF DESCRIPTION OF THE DRAWINGS

These and/or other aspects and advantages of the present disclosure will become apparent and more readily appreciated from the following description of the embodiments, taken in conjunction with the accompanying drawings of which:

FIG. 1 is a block diagram illustrating an exemplary image forming system according to an embodiment of the present disclosure;

FIG. 2 is a block diagram illustrating an exemplary host apparatus according to an embodiment of the present disclosure;

FIG. 3 is a block diagram illustrating an exemplary image forming apparatus according to an embodiment of the present disclosure;

FIG. 4 is a view illustrating an exemplary composing operation of a copy protection pattern according to an embodiment of the present disclosure;

FIG. 5 is a view illustrating an exemplary user interface window that can be displayed in a user interface unit;

FIG. 6 is a view illustrating an exemplary change in a concentration of a copy protection pattern depending on a concentration of an image according to an embodiment of the present disclosure;

FIG. 7 is a flowchart illustrating an exemplary a print control method according to an embodiment of the present disclosure;

FIG. 8 is a flowchart illustrating an exemplary image forming method according to an embodiment of the present disclosure;

FIG. 9 is a flowchart illustrating an exemplary image processing method according to an embodiment of the present disclosure; and

FIG. 10 is a flowchart illustrating an exemplary image processing method.

Throughout the drawings, like reference numerals refer to like parts, components and structures.

### DETAILED DESCRIPTION

Exemplary embodiments of the present disclosure are described in detail with reference to the accompanying drawings.

The matters defined herein, such as a detailed construction and elements thereof, are provided to assist in a comprehensive understanding of an exemplary embodiment of the present invention. Thus, it is apparent that certain exemplary embodiments may be carried out without those defined matters. Also, well-known functions or constructions are omitted to provide a clear and concise description of exemplary embodiments.

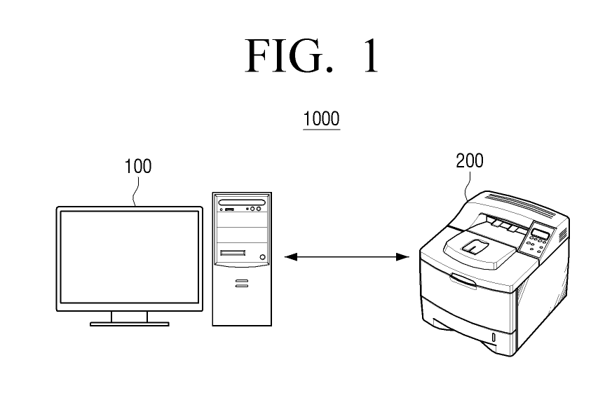

FIG. 1 is a block diagram illustrating an exemplary image forming system according to an embodiment of the present disclosure.

Referring to FIG. 1, an image forming system 1000 includes a host apparatus 100 and an image forming apparatus 200.

The host apparatus 100 may generate printing data for a document, and transmit the generated printing data to the image forming apparatus 200. The host apparatus 100 may include personal computers (PCs), notebook computers, mobile phones, smart phones, portable multimedia players (PMPs), MP3 players, etc. that can generate the printing data.

The image forming apparatus 200 may print the printing data. The image forming apparatus 200 may perform a printing for the printing data received from the host apparatus 100, scan images scanned by the image forming apparatus 200 itself, or pre-stored document files. The image forming apparatus 200 may include one or more printers, copiers, facsimile machines, and/or multi function peripherals (MFPs) to implement a plurality of these functions through a single device.

An image forming system 1000 according to an embodiment of the present disclosure may be formed so that at least one of the host apparatus 100 and the image forming apparatus 200 may compose a copy protection pattern and image data so that the copy protection pattern is printed with a concentration corresponding to a printing concentration of an object to be printed.

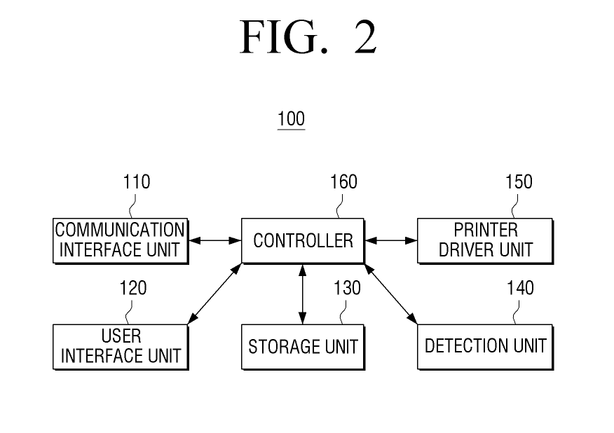

The host apparatus 100 may generate printing data in which the document and the copy protection pattern are composed in a generation process of the printing data, and may transmit the generated printing data to the image forming apparatus 200. Since composition of the copy protection pattern and the image data is performed in the host apparatus 100, the host apparatus 100 may be connected to a conventional image forming apparatuses as well as the image forming apparatus according to an embodiment of the present disclosure. An exemplary configuration and operation of the host apparatus 100 according to an exemplary embodiment are described with regard to FIG. 2.

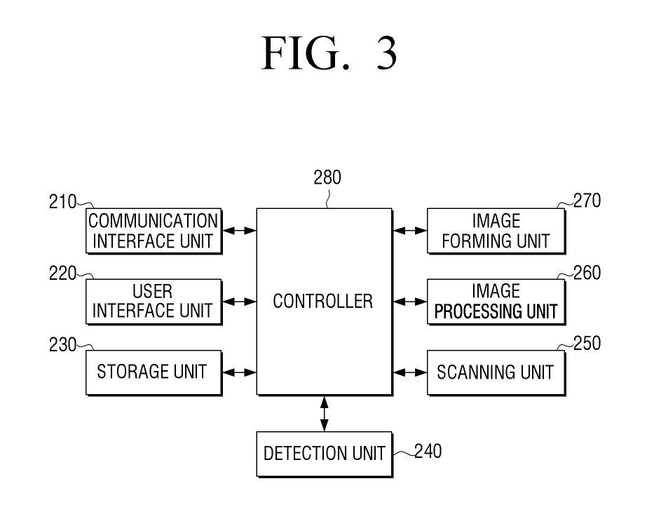

A host apparatus 100 may generate general printing data (namely, printing data with which the copy protection pattern is not composed), and then may transmit the general printing data to the image forming apparatus 200. The image forming apparatus 200 may compose the received printing data and the copy protection pattern, and then may print the printing data with the copy protection pattern. Since the image forming apparatus 200 may perform composition of the copy protection pattern and the printing data, the image forming apparatus 200 may be connected to conventional host apparatuses as well as the host apparatus according to an embodiment of the present disclosure. An exemplary configuration and operation of the image forming apparatus 200 according to an exemplary embodiment are described with regard to FIG. 3.

An image forming apparatus 200 may compose pre-stored data or an image scanned by a scanning unit and the copy protection pattern, and may print a scan image (or the pre-stored data) with the copy protection pattern. Since the composition of the copy protection pattern and the scan image may be performed in the image forming apparatus 200, the image forming apparatus 200 may be connected to a conventional host apparatuses as well as the host apparatus according to an embodiment of the present disclosure. An exemplary configuration and operation of the image forming apparatus 200 according to the present embodiment is described with regard to FIG. 3.

Since the image forming system 1000 according to an embodiment of the present disclosure may be formed so that the host apparatus 100 or the image forming apparatus 200 composes the copy protection pattern and the image data, a user may easily output a printout with the copy protection pattern. Since the concentration of the copy protection pattern may be adjusted depending on the printing concentration of the image data in the composing process of the copy protection pattern and then the copy protection pattern is printed, unnecessary toner consumption may be reduced.

As illustrated in FIG. 1, the host apparatus 100 may be connected to a single image forming apparatus 200, but the host apparatus 100 may be connected to a plurality of image forming apparatuses 200. The image forming apparatus 200 may also be connected to a plurality of host apparatuses 100.

FIG. 1 illustrates a host apparatus 100 directly connected to the image forming apparatus 200. However, the host apparatus 100 and the image forming apparatus 200 may be indirectly connected to each other through a router, etc., or may be connected to each other by a wireless and/or wired connection.

FIG. 2 is a block diagram illustrating an exemplary host apparatus according to an embodiment of the present disclosure.

Referring to FIG. 2, the host apparatus 100 according to an embodiment of the present disclosure may include a communication interface unit 110, a user interface unit 120, a storage unit 130, a detection unit 140, a printer driver unit 150, and a controller 160. The host apparatus 100 may include a personal computer, a notebook computer, a personal digital assistant (PDA), a portable multimedia player (PMP), a mobile phone, etc. that can generate printing data.

The communication interface unit 110 may be formed to connect the host apparatus 100 to an external apparatus (e.g., the image forming apparatus 200). The communication interface unit 110 may be connected to the image forming apparatus 200 through a universal serial bus (USB) port and a wireless communication method, and/or a local area network (LAN), and/or an internet network.

The communication interface unit 110 receives status information from the image forming apparatus 200. The status information may include information about operational availability of the image forming apparatus 200 and toner information (e.g., information about an amount of toner (if the image forming apparatus has a plurality of toners, information about the amount of toner by each of the plurality of toners)).

The communication interface unit 110 transmits the printing data to the image forming apparatus 200. The communication interface unit 110 may transmit the printing data generated in the printer driver unit 150 to the image forming apparatus 200. According to an exemplary embodiment, the printer driver unit 150 generates and transmits the printing data to the image forming apparatus 200. The image forming apparatus 200 may support a direct printing, and may be implemented so that the communication interface unit 110 transmits an image file in which the copy protection pattern is added to the image forming apparatus 200. The communication interface unit 110 may individually transmit an image of the copy protection pattern, a file itself, and composition information thereof to the image forming apparatus 200. The image forming apparatus 200 may be implemented to compose the image of the copy protection pattern and the file that are individually received based on the composition information, and then to print the file with the copy protection pattern.

The user interface unit 120 includes a plurality of functional keys for the user to set or select a variety of functions supported by the host apparatus 100, and displays a variety of information provided by the host apparatus 100. The user interface unit 120 may be implemented as an apparatus that can perform both input and output such as a touch screen or as an apparatus formed by a connection of a mouse and a monitor.

The user interface unit 120 receives a print command for a printing job. The user may select a printing job (or print file) to be printed out and printing options to be applied to the selected printing job by using the user interface unit 120. The selected printing options may be to apply the copy protection pattern. According to an exemplary embodiment, only when the user selects the copy protection pattern as the printing option, is the copy protection pattern applied to the printing. Alternatively, according to an exemplary embodiment, even when the user does not select the copy protection pattern, the copy protection pattern may be applied to the printing.

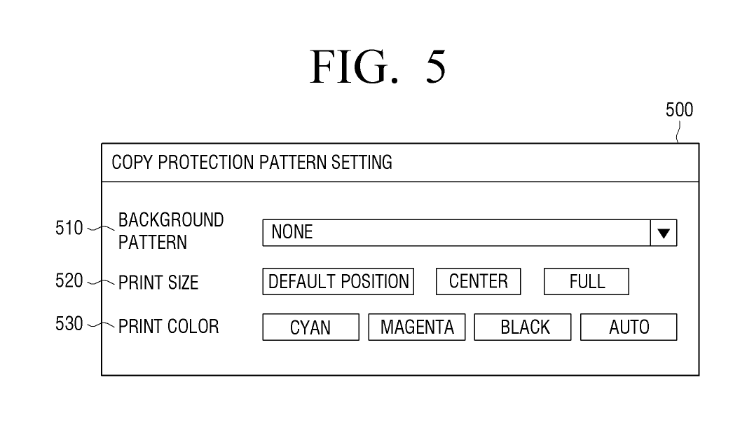

The user interface unit 120 may receive at least one option selected among options for the copy protection pattern. If the user selects the copy protection pattern as the printing option, the user interface unit 120 may receive options selected for the copy protection pattern. The options for the copy protection pattern may include a shape of the copy protection pattern to be applied, a printing location of the copy protection pattern, a color of the copy protection pattern, etc. An example of a user interface window that can be displayed in the user interface unit 120 for receiving the options that will be selected by the user is illustrated in FIG. 5.

The storage unit 130 may store various printing jobs. The storage unit 130 may store the status information of the image forming apparatus 200 received through the above-described communication interface unit 110. Such status information may be updated periodically. If the host apparatus 100 is connected to a plurality of image forming apparatuses 200, the storage unit 130 may separate and store the status information of each of the plurality of image forming apparatuses 200.

The storage unit 130 may temporarily store the printing data generated in the printer driver unit 150. The storage unit 130 may store the copy protection pattern. The copy protection pattern may be character shapes, such as “copy prohibited”, “copy”, etc., or a special mark with a number of shapes, for example, five circular shapes for preventing from copying the bill. Depending on the distances between the circular shapes, arrangement of the circular shapes, etc., the copy protection patterns used in various countries may be different from each other.

The storage unit 130 may be implemented as a storage medium within the host apparatus 100, and an external storage medium, for example, a removable disk including a USB memory, a web server through a network, etc.

The detection unit 140 detects a printing concentration of a document. The detection unit 140 may calculate the amount of toner required to print various objects (e.g., text, image) contained in the document. The detection unit 140 may calculate the amount of toner required to print the document by considering various printing options applied to the document (or default printing options set in the image forming apparatus). For example, when printing is performed in a state in which the print quality is set in a normal mode, the required amount of toner may be set at a value of 100. However, when the printing is performed in a state in which the print quality is set in a saving mode, the required amount of toner may be smaller than a value of 100.

Even when the user sets the printing quality the normal mode in the host apparatus 100, if the image forming apparatus 200 operates in an echo mode, the image forming apparatus 200 may print by automatically changing the printing quality from the normal mode to the saving mode. Accordingly, the detection unit 140 may calculate the amount of toner that the image forming apparatus 200 actually requires to print the document by considering these items.

The detection unit 140 may detect a printing area of the document. The detection unit 140 may detect a printing concentration by considering the calculated amount of toner and the detected printing area. The user may perform a printing work on only some area of a printing medium. The amount of used toner may be less than when the printing work is performed on the entire area of the printing medium. Accordingly, if the concentration of the copy protection pattern is determined by considering only the amount of toner, the copy protection pattern for which the concentration is much lower than the concentration required for the document of which the printing work is performed on only some area may be printed. Therefore, the detection unit 140 may determine the printing concentration by considering the amount of toner required for printing the document and the printing area of the document.

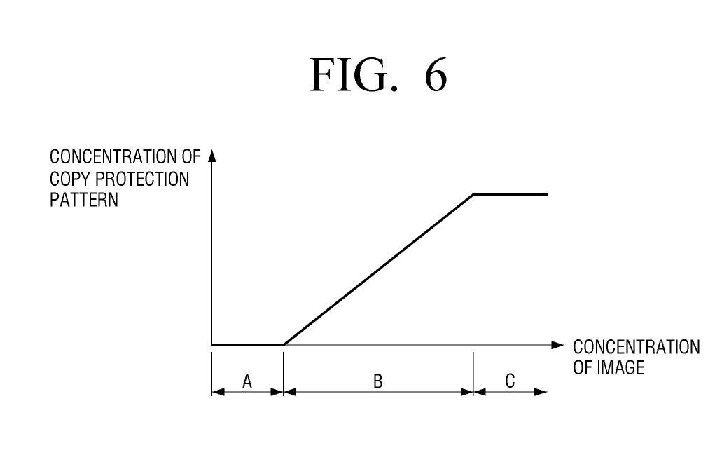

The printer driver unit 150 generates the printing data for the printing job. When the copy protection pattern needs to be applied, the printer driver unit 150 may determine the printing concentration of the copy protection pattern corresponding to the printing concentration of the document detected in the detection unit 140. The printer driver unit 150 may determine the printing concentration of the copy protection pattern such as the graph characteristics as illustrated in FIG. 6.

For example, as illustrated in FIG. 6, if the detected printing concentration of the document is higher than a first predetermined concentration (a boundary between a section B and section C), that is, if the detected printing concentration of the document is in the section C illustrated in FIG. 6, a predetermined concentration may be determined as the concentration of the copy protection pattern.

If the detected printing concentration of the document is lower than the first predetermined concentration (the boundary between section B and section C) as illustrated in FIG. 6, e.g., if the detected printing concentration of the document is in section B of FIG. 6, the concentration of the copy protection pattern may be determined to be a concentration lower than the predetermined concentration for the copy protection pattern (in detail, a concentration proportional to the detected printing concentration).

If the detected printing concentration of the document is lower than a second predetermined concentration (a boundary between section A and section B) as illustrated in FIG. 6, namely, if the detected printing concentration of the document is in the section A of FIG. 6, the concentration of the copy protection pattern may be determined to be zero (0). In other words, when a document with a very light concentration is printed, printing of the copy protection pattern is not required so that the copy protection pattern does not need to be combined with the document. Accordingly, in this case, processing may occur so that only image data are printed in later operations.

The printer driver unit 150 generates printing data in which the document and the copy protection pattern are composed. The printer driver unit 150 may compose the document and the copy protection pattern having a concentration previously determined in order for the copy protection pattern to be printed with a concentration corresponding to the detected printing concentration of the document, and may generate printing data for the document in which the copy protection pattern is inserted. A composition may be defined as a copy protection pattern inserted in the rendered document. The copy protection pattern may be inserted in a CMYK color space.

The printer driver unit 150 may compose the copy protection pattern and the document by considering the option for the copy protection pattern received from the user interface unit 120 or the default option for the copy protection pattern. When the option (a color, a location, and a pattern shape) for the copy protection pattern selected by the user is received through the user interface unit 120, the printer driver unit 150 may compose the copy protection pattern and the document by reflecting the selected option. If the user sets the option for color as “auto”, the printer driver unit 150 may determine the color of toner of which the image forming apparatus 200 has the most amount as the color of the copy protection pattern.

If the user does not select a location option of the copy protection pattern, the printer driver unit 150 may determine an area on which the copy protection pattern is placed by considering the printing area of the document. For example, since the user may perform the printing work on some area of the printing medium, if the default set location of the copy protection pattern is different from the printing area, the copy protection pattern may be placed on an area different from the printing area so that the copy protection pattern is unnecessarily printed. Accordingly, the printer driver unit 150 may determine the location of the copy protection pattern by considering the printing area.

The printer driver unit 150 may perform image composition for the document and the copy protection pattern. However, the printer driver unit 150 may be implemented not to perform image composition but to generate the printing data in which the information for the document and the information for the copy protection pattern (information of the image, concentration, color, location, etc. of the copy protection pattern) are contained. In this case, the substantial image composition may be performed in the image forming apparatus 200.

The controller 160 controls each of components within the host apparatus 100. When the controller 160 receives a print command for the printing job through the user interface unit 120, the controller 160 may control the detection unit 140 to detect the printing concentration for the document. The controller 160 may determine the concentration of the copy protection pattern corresponding to the detected printing concentration of the document. The controller 160 may control the printer driver unit 150 to generate printing data in which the copy protection pattern and the document are composed with the determined concentration of the copy protection pattern.

The controller 160 may control the communication interface unit 110 to transmit the generated printing data to the image forming apparatus 200.

Accordingly, since the host apparatus 100 according to an embodiment of the present disclosure composes the copy protection pattern and the image data using software, the user can easily print the printout with the copy protection pattern although separate dedicated printing media are not used. Since the host apparatus 100 may print by adjusting the concentration of the copy protection pattern depending on the printing concentration of the image data in the composition process of the copy protection pattern, unnecessary toner consumption may be reduced.

As illustrated in FIG. 2, each of the detection unit 140, the printer driver unit 150, and the controller 160 may be formed separately. However, they may be implemented so as to be combined with each other. For example, the detection unit 140 and the printer driver unit 150 may be implemented as a single component. The detection unit 140 and the controller 160 may be implemented as a single component. The detection unit 140, the printer driver unit 150, and the controller 160 may be implemented as a single component.

An operation to compose the document and the copy protection pattern may be performed in the image forming apparatus. An exemplary image forming apparatus 200 is described with reference to FIG. 3.

FIG. 3 is a block diagram illustrating an exemplary an image forming apparatus according to an embodiment of the present disclosure.

Referring to FIG. 3, the image forming apparatus 200 may include a communication interface unit 210, a user interface unit 220, a storage unit 230, a detection unit 240, a scanning unit 250, an image processing unit 260, an image forming unit 270, and a controller 280.

The communication interface unit 210 may be formed to connect the image forming apparatus 200 to an external apparatus. The communication interface unit 210 may be connected to the host apparatus 100 through a universal serial bus (USB) port as well as a local area network (LAN) and an internet network.

The communication interface unit 210 may receive printing data. The communication interface unit 210 may transmit status information of the image forming apparatus 200 to the host apparatus 100. The status information may include information about operational availability of the image forming apparatus 200 and toner information (information about the amount of toner (if the image forming apparatus has a plurality of toners, information about the amount of each of the plurality of toners)). The printing data may be received from the host apparatus 100. However, if the image forming apparatus 200 can perform a direct printing, the communication interface unit 210 may receive a file itself as the printing data. The direct printing may be defined as a printing work that may be performed by only an operation to transmit the file itself to the image forming apparatus.

The user interface unit 220 includes a plurality of functional keys for the user to set or select a variety of functions supported by the image forming apparatus 200, and displays a variety of information provided by the image forming apparatus 200. The user interface unit 220 may be implemented as an apparatus that can perform both input and output such as a touch screen or as an apparatus formed by connection of a mouse and a monitor.

The user interface unit 220 receives a job performing command. The job performing command may be a copy command to scan and print the document, or a print command to print a file stored in the image forming apparatus 200. According to an exemplary embodiment, the job performing command may be received through the user interface unit 220. However, if the job performing command is the print command for the printing data, the job performing command may be received through the communication interface unit 210.

The user interface unit 220 may receive at least one option selected among options for the copy protection pattern. If the user selects the copy protection pattern as the printing option, the user interface unit 220 may receive options for the copy protection pattern selected by the user. The options for the copy protection pattern may include a shape of the copy protection pattern to be applied, a printing location of the copy protection pattern, a color of the copy protection pattern, etc. An example of a user interface window that can be displayed by the user interface unit 220 for receiving the options that may be selected by the user is illustrated in FIG. 5.

According to an exemplary embodiment, only when the user selects the copy protection pattern as the printing option, the copy protection pattern is applied to the printing. However, alternatively, according to an exemplary embodiment, even when the user does not select the copy protection pattern, the copy protection pattern is applied to the printing. The selected option for the copy protection pattern may be received through the user interface unit 220 equipped in the image forming apparatus 200. However, according to an exemplary embodiment, the selected option for the copy protection pattern is received from the external apparatus (e.g., the host apparatus).

The storage unit 230 may store various files. The storage unit 230 may store the status information of the image forming apparatus 200. Such status information may be updated periodically by the controller 280. The status information includes the amount of toner of each of the plurality of toners detected by the detection unit 240 as will be described later.

The storage unit 230 may store the printing data received through the above-described communication interface unit 210. The storage unit 230 may store scan images generated by the scanning unit 250. The storage unit 230 may temporarily images composed by the image processing unit 260.

The storage unit 230 may store the copy protection pattern. The copy protection pattern may be character shapes, such as “copy prohibited”, “copy”, etc., or a special mark with a number, for example, five circular shapes for preventing from copying the bill. Depending on the distances between the circular shapes, arrangement of the circular shapes, etc., the copy protection patterns used in various countries may be different from each other.

The storage unit 230 may be implemented as a storage medium within the image forming apparatus 200, and an external storage medium, for example, a removable disk including a USB memory, a web server through a network, etc.

The detection unit 240 detects a printing concentration for image data. The detection unit 240 may detect the printing concentration of the image data based on the amount of toner required to print various objects (e.g., text, image) contained in the image data. If a current job is a printing work for the printing data received through the communication interface unit 210, the detection unit 240 may detect the printing concentration of the received printing data. On the other hand, if the current job is a printing work for the scan image, the detection unit 240 may detect a printing concentration of the scan image that was scanned and generated by the scanning unit 250. If the current job is a printing work for a pre-stored file, the detection unit 240 may detect a printing concentration of the pre-stored file. Hereinafter, to facilitate the description, both the communication interface unit 210 and scanning unit 250 may be referred to as an input unit. All the printing data received through the communication interface unit 210, the scan images received through the scanning unit 250, and the files pre-stored in the storage unit 130 may be referred to as the image data. Detailed detecting operation of the printing concentration of the printing data is the same as that of the detection unit 140 of FIG. 2. Therefore, detailed description thereof will be omitted.

If the image forming apparatus 200 can perform a color printing by using a plurality of different toners, the detection unit 240 may detect the amount of toner of each of the plurality of toners. The detection unit 240 may store the detected amount of the toner of each of the plurality of toners in the storage unit 230 as the status information. Such detection of the amount of toner may be performed periodically, or every time the print work is complete.

The detection unit 240 determines whether the document scanned by the scanning unit 250 as will be described later includes a predetermined pattern (e.g., a copy protection pattern). According to an exemplary embodiment, a detection unit 240 determines whether the scan document includes the pattern. According to an exemplary embodiment, a determining operation is performed in the scanning unit 250 or the image processing unit 260.

The scanning unit 250 scans the document. If the job performing command of the user is the copy command, the scanning unit 250 may scan the document, and then may generate a scan image.

The image processing unit 260 performs rendering for the job. When the printing data are received through the communication interface unit 210, the image processing unit 260 generates image data by performing parsing and rendering for the received printing data.

The image processing unit 260 may perform a color conversion for the generated image data. The image processing unit 260 may perform the color conversion from the printing data rendered by the above-described process and the scan image with RGB scanned in the scanning unit 250 to the image data with the CMYK color values.

If it is required to apply the copy protection pattern, the image processing unit 260 may determine the printing concentration of the copy protection pattern corresponding to the printing concentration of the image data detected in the detection unit 240. The image processing unit 260 may determine the printing concentration of the copy protection pattern such as the graph characteristics as illustrated in FIG. 6. An operation to determine the printing concentration of the copy protection pattern may be the same as the operation of the printer driver unit 150 of FIG. 2, therefore, a detailed description thereof will be omitted.

The image processing unit 260 composes the image data and the copy protection pattern. The image processing unit 260 may compose the copy protection pattern and the image data based on the concentration of the copy protection pattern determined in the previous process.

For example, as illustrated in FIG. 6, if the detected printing concentration is lower than a first predetermined concentration (a boundary between section B and section C) (in a case of section B of FIG. 6), the image processing unit 260 may compose the image data and the copy protection pattern so that the copy protection pattern can be printed with a concentration lower than a predetermined concentration for the copy protection pattern (in detail, a concentration proportional to the detected printing concentration). On the other hand, if the detected printing concentration is higher than the first predetermined concentration (in a case of section C of FIG. 6), the image processing unit 260 may compose the image data and the copy protection pattern so that the copy protection pattern may be printed with the predetermined concentration of the copy protection pattern. The composition may be defined as to insert the copy protection pattern into the image data.

On the other hand, if the detected printing concentration is a second concentration (a boundary between section A and section B) lower than the first predetermined concentration, namely, if the copy protection pattern is an image as light as the image does not need to be printed, a separate composition may not be performed so that only the image data can be printed.

The image processing unit 260 may compose the copy protection pattern and the image data by considering the options for the copy protection pattern selected in the user interface unit 220 (or the options for the copy protection pattern received through the communication interface unit 210) and the default options for the copy protection pattern. When the option (a color, a location, and a pattern shape) for the copy protection pattern is received through the user interface unit 220, the image processing unit 260 may compose the copy protection pattern and the image data by reflecting the selected option.

If the user sets the option for color as “auto”, the image processing unit 260 may determine the color of toner having the largest amount of toner as the color of the copy protection pattern.

If the user does not select a location option of the copy protection pattern, the image processing unit 260 may determine an area on which the copy protection pattern is placed by considering the printing area of the image data. For example, since the user may perform the printing work on some area of the printing medium, if the default set location of the copy protection pattern is different from the printing area, the copy protection pattern is placed on an area different from the printing area so that the copy protection pattern may unnecessarily be printed. Accordingly, the image processing unit 260 may determine the location of the copy protection pattern by considering the printing area, and then may compose the copy protection pattern and the image data depending on the location determined by the above-described process.

The image forming unit 270 prints the image data in which the copy protection pattern is inserted. The image forming unit 270 may print the image data in which the copy protection pattern is inserted generated in the image processing unit 260. On the other hand, when the copy protection pattern is not inserted into the image data since the concentration of the image data is lower than the second predetermined concentration, the image forming unit 270 may print the image data in which the copy protection pattern is not inserted. On the other hand, according to an exemplary embodiment, even when the concentration of the image data is lower than the second concentration, the printing work may be performed. However, when the concentration of the image data is lower than the second concentration, according to an exemplary embodiment it may be implemented so that the printing work is not performed, or the user confirms whether to perform the printing work.

The controller 280 controls each of components within the image forming apparatus 200. When the controller 280 receives the job performing command through the communication interface unit 210 or the user interface unit 220, the controller 280 may control the detection unit 240 to detect the printing concentration of the printing data received through the communication interface unit 210 or the scan image scanned through the scanning unit 250.

After the printing concentration is detected, the controller 280 may control the image processing unit 260 to compose the copy protection pattern and the image data so that the copy protection pattern is printed with the concentration corresponding to the detected printing concentration. The controller 280 may control the image forming unit 270 to print the image data in which the copy protection pattern is inserted.

If the detection unit 240 detects a copy protection pattern from the scanned document during the printing work of the scan document, the controller 280 stops the printing work of the scan document containing the copy protection pattern, and may indicate information that the scan document cannot be printed to the user through the user interface unit 220. Alternatively, if the copy protection pattern is detected from the scan document, the controller 280 may be implemented to control the image processing unit 260 to compose the scan document and another copy protection pattern different from the detected copy protection pattern. For example, when the user copies money, the detection unit 240 may detect the special mark with the five circular shapes. The controller 280 may control the image processing unit 260 and the image forming unit 270 so that a copy protection pattern such as “COPY”, “COUNTERFEIT BILL” and a money image are composed, and then printed.

Accordingly, since the image forming apparatus 200 according to an embodiment of the present invention composes the copy protection pattern and the image data using software, the user can easily print the printout with the copy protection pattern although separate dedicated printing media are not used. Since the image forming apparatus 200 may print by adjusting the concentration of the copy protection pattern depending on the printing concentration of the image data in the composition process of the copy protection pattern, unnecessary toner consumption may be reduced.

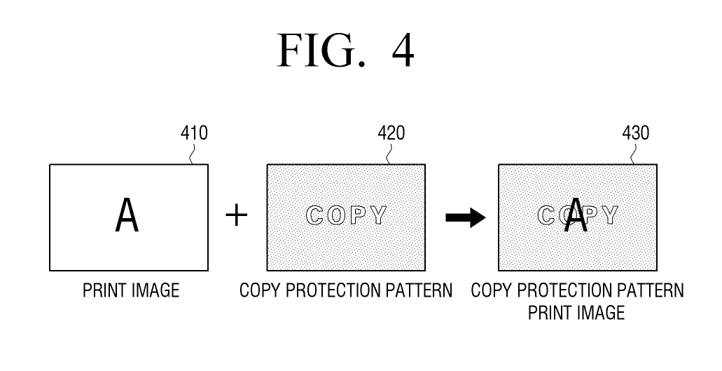

FIG. 4 illustrates an exemplary operation of a copy protection pattern according to an embodiment of the present invention.

Referring to FIG. 4, an image data 410 and a copy protection pattern are mutually overlaid, and then composed into a single print image 430. During the composition, each of the image data 410 and the copy protection pattern 420 may be image data having CMYK values. Accordingly, before performing the composition, the image processing unit 260 may proactively perform an image process to convert the printing data and the scan image into image data with CMYK values.

FIG. 5 is a view illustrating an exemplary a user interface window that can be displayed in a user interface unit of FIG. 2 or 3.

Referring to FIG. 5, a user interface unit 500 includes an area in which a type of pattern is selected 510, an area in which a location of pattern is selected 520, and an area in which a color of pattern is selected 530.

The area in which a type of pattern is selected 510 is an area in which the user selects a type or a shape of the copy protection pattern to be applied. In an exemplary embodiment as illustrated in FIG. 5, the copy protection pattern is selected by a name of the copy protection pattern. However, it may be implemented so that a form or a shape of the copy protection pattern is displayed.

The area in which a location of pattern is selected 520 is an area in which the user selects an indicating location of the previously selected pattern.

The area in which a color of pattern is selected 530 is an area in which the user selects the color of the previously selected pattern. If the user does not select a specific color, but selects “AUTO”, the color of the toner of which the remaining amount is the largest may automatically be selected as the color of the pattern as described previously. On the other hand, the area in which a color of pattern is selected 530 may be displayed when the image forming apparatus 200 is an image forming apparatus capable of performing a color printing, but may not be displayed when the image forming apparatus 200 is an image forming apparatus capable of performing only black-and-white printing.

FIG. 6 is a view illustrating an exemplary change in a concentration of a copy protection pattern depending on an image concentration according to an embodiment of the present disclosure.

Referring to FIG. 6, the concentration of the copy protection pattern may be applied differently depending on the concentration of the three sections (sections A, B, and C) of the image data.

Section A is a section where the printing concentration of the image data is lower than a second predetermined concentration (a boundary between section A and the section B). When the printing concentration of the image data corresponds to section A, the concentration of the copy protection pattern may be determined as zero (0). If the printing concentration of the image data corresponds to section A, the document may have a very light concentration. Thus, since a small amount of toner may be printed on the actual printout, the document may be identified as a state in which the output of the copy protection pattern is not required, and thus the concentration of the copy protection pattern may be determined as zero.

Section B is a section where the printing concentration of the image data is lower than a first predetermined concentration (a boundary between section B and section C), and higher than the second predetermined concentration (the boundary between section A and section B). If the printing concentration of the image data corresponds to section B, the concentration of the copy protection pattern may be determined as a concentration proportional to the printing concentration of the image data.

Section C is a section where the printing concentration of the image data is higher than the first predetermined concentration (the boundary between section B and section C). If the printing concentration of the image data corresponds to section C, the concentration of the copy protection pattern may be determined as a default concentration.

On the other hand, according to an exemplary embodiment, the concentration of the copy protection pattern may be determined by the three divided sections. However, according to an exemplary embodiment, the concentration may be determined by two divided sections or four or more divided sections. Alternatively, without dividing the concentration into sections, the concentration of the copy protection pattern may be determined at the same rate in the entire concentration range of the image data.

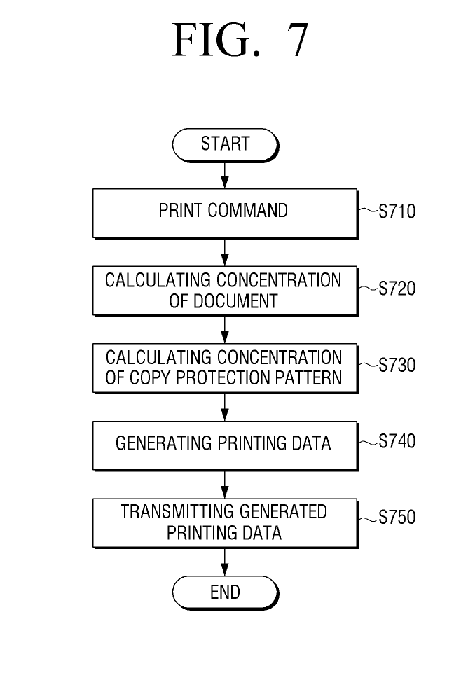

FIG. 7 is a flowchart illustrating an exemplary print control method according to an embodiment of the present disclosure.

Referring to FIG. 7, a print command for a document is received (S710).

A printing concentration of the document is detected (S720). The amount of toner required to print various objects (e.g., text, image) contained in the document may be calculated. The amount of toner required to print the document may be calculated by considering various print options applied to the document (or default print options set in the image forming apparatus). A printing area of the document is detected, and the printing concentration may be detected by considering the calculated amount of toner and the detected printing area.

The concentration of the copy protection pattern corresponding to the detected printing concentration is calculated (S730). The concentration of the copy protection pattern may be calculated proportionally to the detected printing concentration or as the graph characteristics as illustrated in FIG. 6.

A printing data is generated by composing the document and the copy protection pattern (S740). The copy protection pattern and the document may be composed with the previously determined concentration of the copy protection pattern so that the copy protection pattern may be printed with the concentration corresponding to the detected printing concentration of the document. Printing data for the document in which the copy protection pattern is inserted may be generated. The composition may be defined as inserting the copy protection pattern into a rendered document. The copy protection pattern may be inserted in a CMYK color space.

According to an exemplary embodiment, the document and copy protection pattern are substantially composed as the image. However, an exemplary embodiment may be implemented not to perform substantial image composition but to generate the printing data in which the information for the document and the information for the copy protection pattern (information of the image, concentration, color, location, etc. of the copy protection pattern) are contained.

The generated printing data is transmitted to the image forming apparatus (S750).

Accordingly, since the print control method according to an embodiment of the present disclosure composes the copy protection pattern and the image data in a software manner, the user can easily print the printout with the copy protection pattern although separate dedicated printing media are not used. Also, since the concentration of the copy protection pattern is adjusted depending on the printing concentration of the image data in the composition process of the copy protection pattern, and then the image data with the copy protection pattern is printed, unnecessary toner consumption may be reduced. The print control method as illustrated in FIG. 7 may be executed in the host apparatus 100 having the configuration as illustrated in FIG. 2. Alternatively, the print control method may be executed in host apparatuses having different configurations.

A print control method may be implemented as at least one execution program for executing the print control method as described above. Such execution program may be stored in a computer-readable recording medium.

As a result, each of blocks of the present disclosure may be implemented as codes that can be written in the computer-readable recording medium by the computer. The computer-readable recording medium may include devices capable of storing data that can be read by computer systems.

As opposed to a medium to store data for a short moment like a register, a cache, a memory, etc., a non-transitory computer-readable medium is a medium that can store data in a semi-permanent manner and that can be read by devices. The various applications or programs as described above may be stored in the non-transitory computer readable medium, such as a CD, a DVD, a hard disc, a Blu-ray disc, an USB, a memory card, a ROM, etc., and thus, may be provided to.

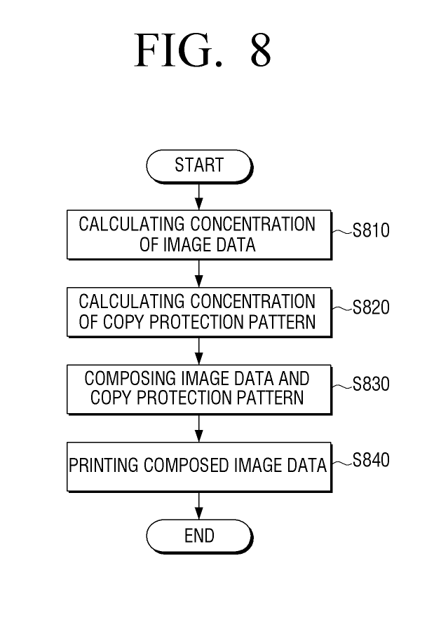

FIG. 8 is a flowchart for explaining an exemplary image forming method of an image forming apparatus according to an embodiment of the present disclosure.

Referring to FIG. 8, if image data is received, a concentration of the image data is calculated (S810). In detail, an amount of toner required to print various objects (e.g., text, image) contained in the image data may be calculated. The amount of toner required to print the image data may be calculated by considering various print options applied to the image data (or default print options set in the image forming apparatus). A printing area of a printing medium on which the image data is printed is detected, and then the printing concentration may be detected by considering the calculated amount of toner and the detected printing area.

The concentration of the copy protection pattern is calculated (S820). The concentration of the copy protection pattern may be calculated proportionally to the detected printing concentration or as the graph characteristics as illustrated in FIG. 6.

The image data and the copy protection pattern are composed (S830). The copy protection pattern and the document may be composed with the previously determined concentration of the copy protection pattern so that the copy protection pattern may be printed with the concentration corresponding to the detected printing concentration of the document. The composition may be defined as to insert the copy protection pattern into the image data.

The image data in which the copy protection pattern is inserted is printed (S840).

Accordingly, since the image forming method according to an embodiment of the present disclosure composes the copy protection pattern and the image data in a software manner, the user can easily print the printout with the copy protection pattern although separate dedicated printing media are not used. Also, since the concentration of the copy protection pattern is adjusted depending on the printing concentration of the image data in the composition process of the copy protection pattern, and then the image data with the copy protection pattern is printed, unnecessary toner consumption may be reduced. The image forming method as illustrated in FIG. 8 may be executed in the image forming apparatus 200 having the configuration as illustrated in FIG. 3. Alternatively, the image forming method may be executed in image forming apparatuses having different configurations.

Also, the image forming method as described above may be implemented as at least one execution program for executing the image forming method as described above. Such execution program may be stored in a computer-readable recording medium.

As a result, each of blocks of the present disclosure may be implemented as codes that can be written in the computer-readable recording medium by the computer. The computer-readable recording medium may include devices capable of storing data that can be read by computer systems.

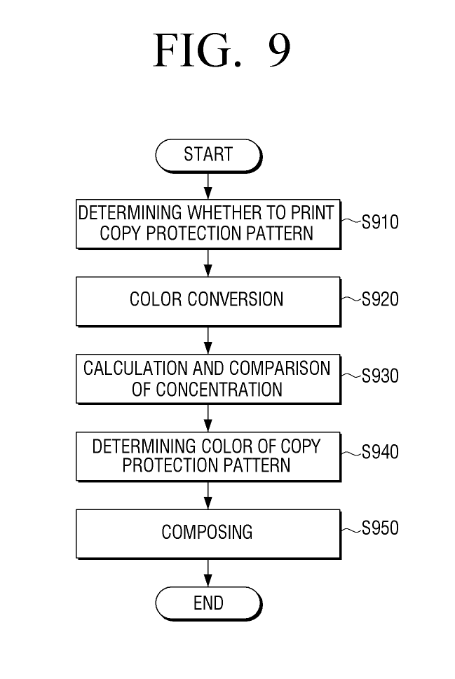

FIG. 9 is a flowchart for explaining an exemplary image processing method according to an embodiment of the present disclosure.

Referring to FIG. 9, whether to print a copy protection pattern is determined (S910). Whether to print the copy protection pattern is determined based on options selected by the user, etc.

If the printing of the copy protection pattern is determined necessary, a color conversion for printing data or scan data is performed (S920). According to an exemplary embodiment, in printing data, a printing image is generated by performing parsing and rendering, and then a RGB printing image may be converted into a CMYK printing image. In the case of the scan image, RGB scan images may be converted into CMYK scan images.

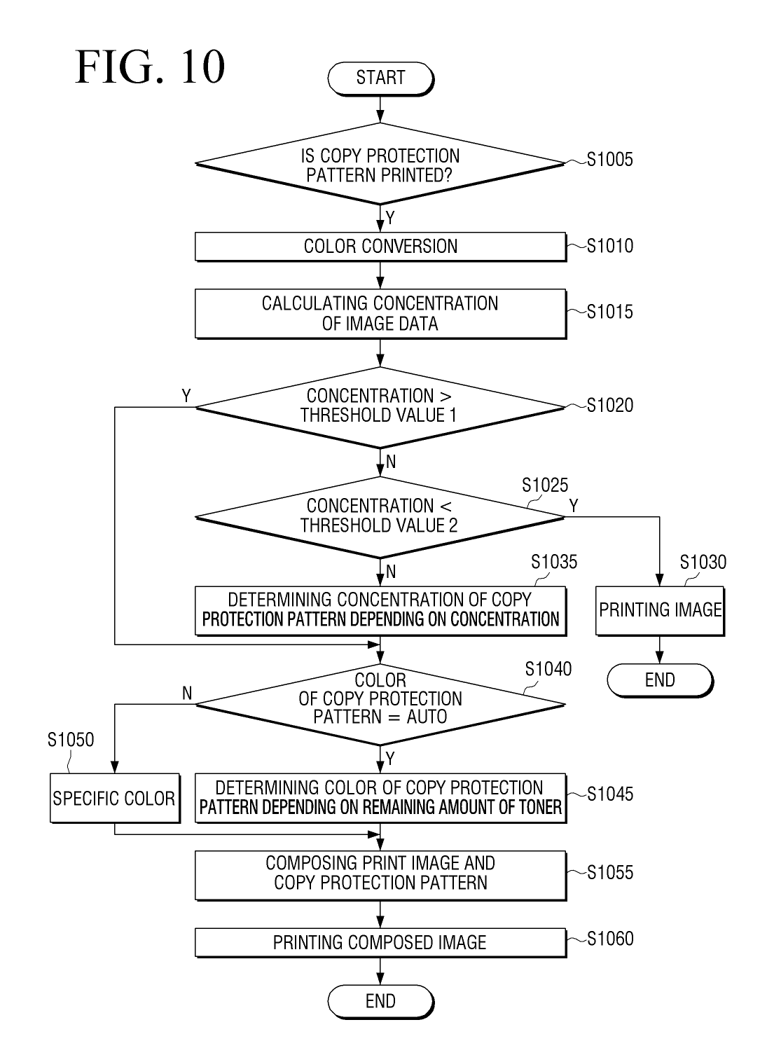

The concentration of the image data to be printed is determined, and then the concentration of a copy protection pattern to be inserted is determined (S930). Then, a color of the copy protection pattern is determined (S940). The determining operations (S930 and S940) will be described hereinafter with reference to FIG. 10.

The copy protection pattern and the image data are composed based on the determined concentration and color of the copy protection pattern (S950).

Accordingly, since the image processing method according to an embodiment of the present disclosure adjusts the concentration of the copy protection pattern depending on the printing concentration of the image data in the composition process of the copy protection pattern, unnecessary toner consumption may be reduced. The image processing method as illustrated, for example, in FIG. 9 may be executed in the host apparatus 100 having the configuration as illustrated in FIG. 2 or the image forming apparatus 200 having the configuration as illustrated in FIG. 3. Alternatively, the image processing method may be executed in host apparatuses or image forming apparatuses having different configurations.

The image processing method may be implemented as at least one execution program for executing the image processing method. Such an execution program may be stored in a computer-readable recording medium.

As a result, each of blocks of the present disclosure may be implemented as codes that can be written in the computer-readable recording medium by the computer. The computer-readable recording medium may include devices capable of storing data that can be read by computer systems.

FIG. 10 is a flowchart illustrating an exemplary image processing method.

Referring to FIG. 10, whether to print the copy protection pattern is determined (S1005). Whether to print the copy protection pattern is determined based on options selected by the user, etc.

The color conversion for printing data or scan data is performed (S1010). According to an exemplary embodiment, in printing data, a printing image is generated by performing parsing and rendering, and then a RGB printing image may be converted into a CMYK printing image. In the case of the scan image, RGB scan images may be converted into CMYK scan images.

The concentration of the image data to be printed is determined (S1015). In detail, an amount of toner required to print various objects (e.g., text, image) contained in the image data may be calculated. The amount of toner required to print the image data may be calculated by considering various print options applied to the image data (or default print options set in the image forming apparatus). A printing area of a printing medium on which the image data will be printed is detected, and then the printing concentration may be detected by considering the calculated amount of toner and the detected printing area.

Whether the concentration of the image data exceeds a first predetermined threshold value is determined (S1020). If the concentration of the image data exceeds the first predetermined threshold value (S1020-Y), the concentration of the copy protection pattern may be determined as a predetermined concentration (e.g., MAX concentration).

If the concentration of the image data is less than or equal to the first predetermined threshold value (S1020-N), whether the concentration of the image data is less than or equal to a second predetermined threshold value is determined (S1025). If the concentration of the image data does not exceed the second predetermined threshold value (S1025-Y), without a separate composing operation of the copy protection pattern, printing for the image data is performed (S1030).

If the concentration of the image data exceeds the second predetermined threshold value (S1025-N), the concentration of the copy protection pattern is determined proportionally to the detected concentration of the image data (S1035).

Whether the color of the copy protection pattern is set is determined (S1040). Whether the color option for the copy protection pattern is set as AUTO or whether there is a different selection is determined.

If the color of the copy protection pattern is set as AUTO (S1040-Y), the color of the copy protection pattern is determined depending on the remaining amount of toner (S1045).

If the color of the copy protection pattern is set as a specific color, or if the printing is performed by a black-and-white image forming apparatus (S1050), a copy protection pattern corresponding to the selected color or the black color may be determined.

The copy protection pattern and the image data are composed based on the determined color and concentration of the copy protection pattern (S1055).

The image data in which the copy protection pattern is inserted is printed (S1060).

While the embodiments of the present disclosure have been described, additional variations and modifications of the embodiments may occur to those skilled in the art after they learn of the inventive concepts disclosed herein. Therefore, the claims include both the above embodiments and all such variations and modifications that fall within the spirit and scope of the inventive concepts.

What is claimed is:

1. An image forming apparatus comprising:
an input unit that receives image data;
a detection unit that detects a printing concentration of the received image data;
an image processing unit that composes a copy protection pattern and the image data so that the copy protection pattern is printed with a concentration corresponding to the detected printing concentration; and
an image forming unit that prints image data composed with the copy protection pattern.

2. The image forming apparatus of claim 1, wherein
if the detected printing concentration is lower than a first predetermined concentration, the image processing unit composes the copy protection pattern and the image data so that the copy protection pattern is printed with a concentration lower than a predetermined concentration for the copy protection pattern.

3. The image forming apparatus of claim 2, wherein
if the detected printing concentration is lower than the first predetermined concentration, the image processing unit composes the copy protection pattern and the image data so that the copy protection pattern is printed with a concentration proportional to the detected printing concentration.

4. The image forming apparatus of claim 2, wherein
if the detected printing concentration is higher than the first predetermined concentration, the image processing unit composes the copy protection pattern and the image data so that the copy protection pattern is printed with the predetermined concentration for the copy protection pattern.

5. The image forming apparatus of claim 2, wherein
if the detected printing concentration is lower than a second concentration lower than the first predetermined concentration,
the image processing unit does not compose the copy protection pattern and the image data, and
the image forming unit prints the image data with which the copy protection pattern is not composed.

6. The image forming apparatus of claim 1, wherein
the image forming apparatus can perform a color printing by using a plurality of different toners,
the detection unit detects an amount of toner of each of the plurality of toners, and
the image processing unit composes the image data and the copy protection pattern corresponding to a color of the toner having the largest amount of toner based on the detected amount of toner.

7. The image forming apparatus of claim 1, wherein
the image forming apparatus can perform a color printing by using a plurality of different toners, and the image forming apparatus further comprises a user interface unit in which a color of the copy protection pattern is selected; and
wherein the image processing unit composes the image data and the copy protection pattern with the selected color.

8. The image forming apparatus of claim 1, further comprising:
a user interface unit in which at least one of a shape and a location of the copy protection pattern is selected,
wherein the image processing unit composes the image data and the copy protection pattern based on the at least selected one of the shape and location of the copy protection pattern.

9. The image forming apparatus of claim 1, further comprising:
a communication interface unit that performs communication with a host apparatus,
wherein the input unit receives printing data received from the host apparatus through the communication interface unit as the image data.

10. The image forming apparatus of claim 1, further comprising:
a scanning unit that generates a scan image by scanning a document,
wherein the input unit receives the scan image generated by the scanning unit as the image data.

11. A host apparatus connectable to an image forming apparatus, comprising:
a detection unit which detects a printing concentration of a document when a print command for the document is received;
a printer driver unit which generates printing data by composing a copy protection pattern and the document so that the copy protection pattern is printed with a concentration corresponding to the detected printing concentration; and
a communication interface unit which transmits the generated printing data to the image forming apparatus.

12. An image forming method of an image forming apparatus, comprising:
receiving image data;
detecting a printing concentration of the received image data;
composing a copy protection pattern and the image data so that the copy protection pattern is printed with a concentration corresponding to the detected printing concentration; and
printing image data composed with the copy protection pattern.

13. The image forming method of claim 12, wherein
the composing a copy protection pattern and the image data comprises,
if the detected printing concentration is lower than a first predetermined concentration, composing the copy protection pattern and the image data so that the copy protection pattern is printed with a concentration lower than a predetermined concentration for the copy protection pattern.

14. The image forming method of claim 13, wherein
the composing a copy protection pattern and the image data comprises,
if the detected printing concentration is lower than the first predetermined concentration, composing the copy protection pattern and the image data so that the copy protection pattern is printed with a concentration proportional to the detected printing concentration.

15. The image forming method of claim 13, wherein
the composing a copy protection pattern and the image data comprises,
if the detected printing concentration is higher than the first predetermined concentration, composing the copy protection pattern and the image data so that the copy protection pattern is printed with the predetermined concentration for the copy protection pattern.

16. The image forming method of claim 13, wherein
the composing a copy protection pattern and the image data comprises,
if the detected printing concentration is lower than a second concentration lower than the first predetermined concentration, not composing the copy protection pattern and the image data, and
the printing the image data composed with the copy protection pattern comprises printing the image data with which the copy protection pattern is not composed.

17. The image forming method of claim 12, wherein
the image forming apparatus can perform a color printing by using a plurality of different toners,
the detecting a printing concentration of the received image data comprises detecting an amount of toner of each of the plurality of toners, and
the composing a copy protection pattern and the image data comprises composing the image data and the copy protection pattern corresponding to a color of the toner having the largest amount of toner based on the detected amount of toner.

18. The image forming method of claim 12, wherein
the image forming apparatus can perform a color printing by using a plurality of different toners, and
the image forming method further comprises receiving a selected color of the copy protection pattern; and
wherein the composing a copy protection pattern and the image data comprises composing the image data and the copy protection pattern with the selected color.

19. The image forming method of claim 12, further comprising:
receiving at least selected one of a shape and a location of the copy protection pattern,
wherein the composing a copy protection pattern and the image data comprises composing the image data and the copy protection pattern based on the at least selected one of the shape and location of the copy protection pattern.

20. The image forming method of claim 12, wherein
the receiving image data comprises receiving printing data received from a host apparatus as the image data.

21. The image forming method of claim 12, wherein
the receiving image data comprises generating a scan image by scanning a document, and receiving the generated scan image as the image data.

22. A print control method of a host apparatus connectable to an image forming apparatus, comprising:
receiving a print command for a document;
detecting a printing concentration of the document;
generating printing data by composing a copy protection pattern and the document so that the copy protection pattern is printed with a concentration corresponding to the detected printing concentration; and
transmitting the generated printing data to the image forming apparatus.

23. A non-transitory computer-readable recording medium having embodied thereon a program, which, when executed by a computer, performs a method of executing a print control, the method comprising:
receiving a print command for a document;
detecting a printing concentration of the document;
generating printing data by composing a copy protection pattern and the document so that the copy protection pattern is printed with a concentration corresponding to the detected printing concentration; and
transmitting the generated printing data to the image forming apparatus.
